(19) United States
(12) Patent Application Publication
(10) Pub. No.: US 2025/0354616 A1
(43) Pub. Date: Nov. 20, 2025

(54) Switch Valve and Methods Thereof

(71) Applicant: DeltaValve, LLC, Sandy, UT (US)

(72) Inventor: Filiberto R. Jimenez, Sandy, UT (US)

(21) Appl. No.: 18/669,347

(22) Filed: May 20, 2024

(51) Int. Cl. F16K 11/074; C10B 31/00

(52) U.S. Cl. CPC F16K 11/0743; C10B 31/00

(57) ABSTRACT

A four-way switch valve sized to retrofit existing ball valves. The four-way switch valve has an inlet that allows resid to pass through a first orifice in the gate and divert the resid back toward a second and third orifice in the gate. The gate rotates between a first position where the gate seats on the communication port to allow the resid to pass to a first coking drum, a second position where the gate seats on a first and second communication port to allow resid to pass to both a first and second coking drum, a third position, where the gate seats on the communication port to allow the resid to pass to a second coking drum, and a bypass to allow resid to pass through the valve without entering any coking drum.

### TECHNICAL FIELD

The present invention relates to a system and device for directing process fluid into a vessel containing a fluid, distillates, or unconsolidated debris byproduct, such as the several types of coke. Specifically, the present invention relates to a system and device, namely a switch valve, that is coupled to a coke drum, which serves to safely and effectively direct the fluid process into the coke drum for the manufacture of coke, or other byproducts.

### BACKGROUND

In the hydrocarbon processing industry, many refineries recover valuable products from the heavy residual oil that remains after refining operations are completed. This recovery process is known as delayed coking, where two or more large reactors, called coke drums, are used to hold, or delay, the heated feedstock while the cracking takes place. Delayed coking heats heavy distillation fractions (“process” or “resid”) in a tubular furnace or fired heater to create a mixture of hot liquid and vapor which is then fed into one of the coke drums, eg. drum A. The resid in the coke drum is maintained at temperatures greater than about 400° C. under super-atmospheric pressures to allow coking to occur. During the delayed coking process, the heated resid separates the more valuable liquid and gaseous products from solid or semi-solid coke residue. The solid or semi-solid coke left behind accumulates in the drum. When the coke reaches a certain level inside the drum, a switch valve redirects the resid to the empty eg. drum B.

Existing switch valves include ball valves and wedgeplug valves. Over time, both ball valves and wedgeplug valves are known to foul and fail as resid accumulates and coke forms in the valve body and obstructs the operation of the valve. Once the coke is formed a replacement valve must be installed.

To delay replacing the switch vale refineries rely heavily on steam to purge resid from the valve body. While somewhat effective in extending a valve's life, steam is expensive. Moreover, if steam to the valve is lost due to obstruction or failure of the steam production the resulting damage to the valve is likely catastrophic.

As a result, there exists a need for an improved switch valve with ports positioned and spaced to connect to existing piping and allow for retrofitting. A further need exists for an improved valve that isolates the resid from the valve body while consuming less on steam.

### BRIEF SUMMARY

The general purpose of the apparatus and methods disclosed herein is to provide an improved switch valve, while also promoting new options for retrofitting existing delayed coking refinery infrastructure. Specifically, the four-way switch valve improves switch valve technology by introducing isolation valve features. In some embodiments the overall apparatus comprises a housing, a rotor/diverter, a first plate with orifices and a second plate with communication ports inside a housing. The valve opens as one or more of the orifices in the first plate come into alignment with one or more of the communication ports in the second plate. The valve closes as the orifices in the first plate are out of alignment with all of the communication ports in the second plate. Valve seats, installed on either the first plate or the second plate, isolate the process fluid, such as resid, from the interior of the housing as well as steam in the valve body from the resid. The seal of the valve seat is improved by using steam to energize a gap between the rotor/diverter and the first plate to increase the distance of the gap. The seal is further improved by using steam to energize bellows structure in the valve seat.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A shows a perspective view of the ports on a four-way switch valve.

FIG. 1B shows a cutaway view of a four-way switch valve with the housing, rotor/diverter, first plate, second plate and internal ports.

FIG. 2A shows a profile view of a rotor and first plate.

FIG. 2B shows an alternative view of the rotor and first plate with orifices.

FIG. 3 shows the first plate with its orifices.

FIG. 4 shows the second plate with communication ports, discharge channel, and discharge ports.

FIG. 5 shows a cut-away view of a four-way switch valve with the actuator, housing, rotor, first plate and second plate.

FIG. 6 shows a cut-away view of a four-way switch valve.

FIG. 7 shows a cut-away view of a four-way switch valve with the rotor in an orientation.

FIG. 8 shows a cut-away view of a four-way switch valve with a close-up view of a housing cavity and internal parts.

FIGS. 9A-9C shows a cut-away view of a four-way switch valve with the rotor rotating through orientations.

FIG. 10A shows a partial view of a four-way switch valve with a first plate in an orientation opening the valve to drum A only-inactive port is blocked by second plate.

FIG. 10B shows position lockout collar on a stop pin.

FIG. 11A shows a partial view of a four-way switch valve with a first plate in an orientation opening valve to drum A and drum B.

FIG. 11B shows lockout collar in mid position.

FIG. 12A shows a partial view of a four-way switch valve with a first plate in an orientation opening valve to drum B only-inactive port is blocked by second plate.

FIG. 12B shows a position with the lockout collar on a lockout pin.

FIG. 13A shows a partial view of a four-way switch valve with a first plate in an orientation opening valve to bypass only-inactive port is blocked by second plate.

FIG. 13B shows a position with the lockout collar on a stop pin, with lockout pin removed.

FIG. 14 shows closeup of housing cavity with steam chase from housing cavity to discharge channel.

FIG. 15 shows closeup of cutaway housing showing steam chase and valve seat with steam-activated bellows.

FIG. 16 shows a method of using the switch valve.

### DETAILED DESCRIPTION OF THE INVENTION

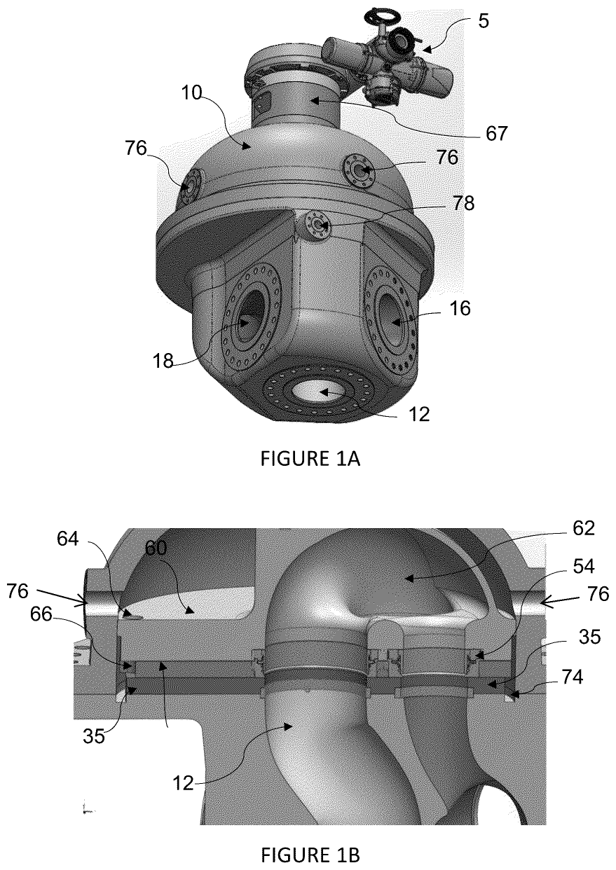

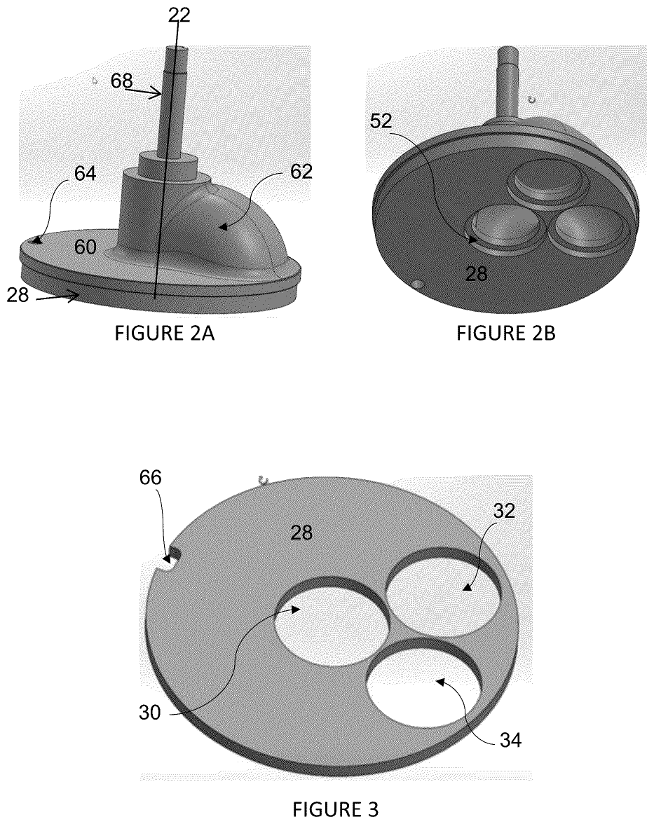

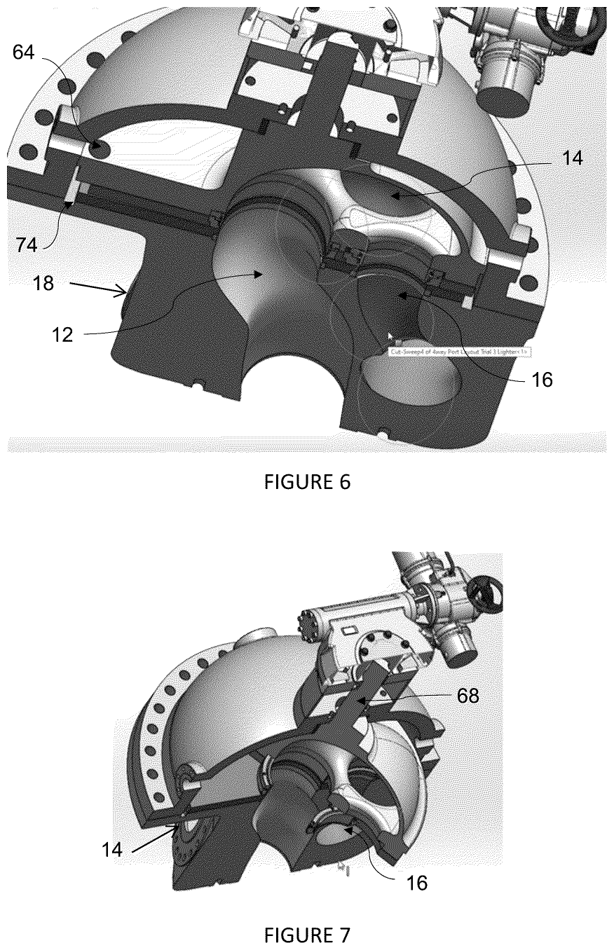

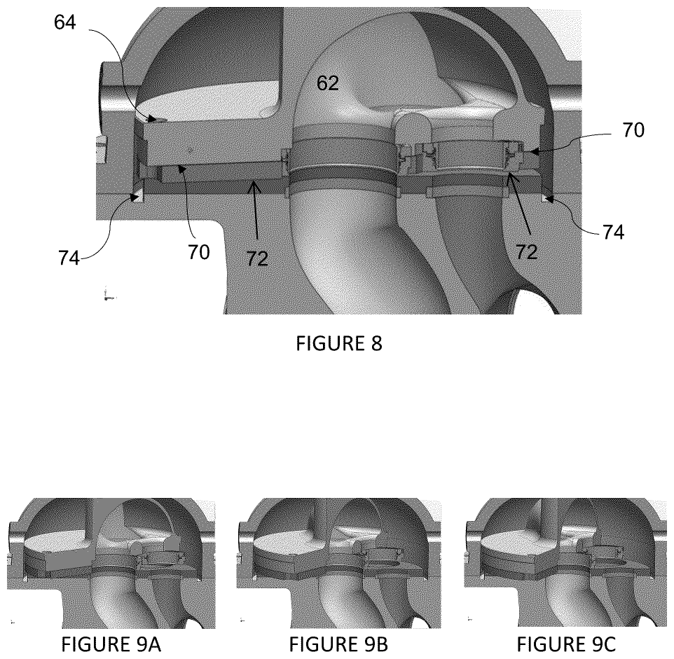

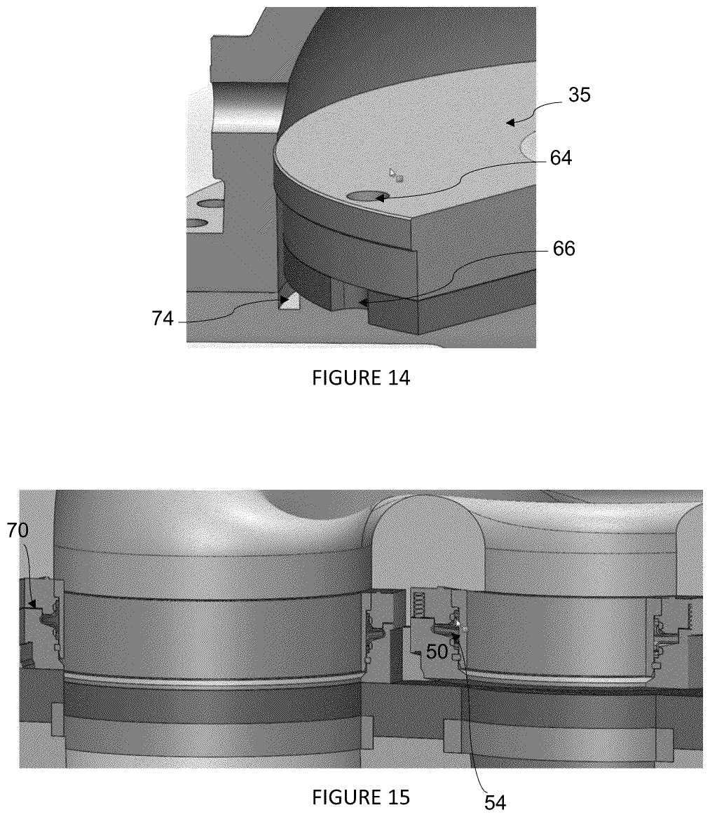

The present embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed descriptions of the embodiments of the apparatus, as represented in FIGS. 1A through 15 are not intended to limit the scope of the invention, as claimed, but are merely representative of present embodiments of the invention.

In general, the figures disclose a switch valve that may be used in connection with delayed coking opening and closing communication ports to coking drums. In some embodiments the switch valve is a four-way switch valve that opens and closes three communication ports.

In the following description, numerous references will be made to valves, plates, gates, containment plates, rotors, diverters, steam purge, and valve seats. However, it should be understood that one of ordinary skill in the art and in possession of this disclosure, would readily understand how the present invention and existing valve structures can be incorporated.

Detailed references will now be made to the preferred embodiments of the present invention, embodiments of which are illustrated in FIGS. 1A-15, which illustrate various views of a switch valve in accordance with one or more embodiments of the invention.

FIGS. 1A-8 illustrate an embodiment of a four-way switch valve. One general aspect includes a switch valve configured to selectively divert resid from a blast furnace into one or more coking drums or into a bypass line. In some embodiments the switch valve is a four-way switch valve 5 also includes a housing 10 may include a plurality of communication ports 12, 14, 16, 18, which may include an inlet port 12 and at least two outlet ports 14, 16. In some embodiments a substantially planar first plate 28 is disposed within the housing 10 where the first plate 28 further may include a plurality of orifices 30, 32, 34. In some embodiments the first plate 28 is configured to selectively rotate to at least partially and selectively open or close communication between an inlet housing port 12 and at least one of the plurality of communication ports 14, 16, 18.

Implementations may include one or more of the following features. In some embodiments a four-way switch valve 5 may comprise a first plate 28 that may further comprise a first orifice 30, where the first orifice 30 and the inlet port 12 are coaxially aligned. In some embodiments the first orifice is an inlet orifice. In some embodiments, coaxially first orifice 30 is sized, shaped, aligned and configured to rotate or revolve around inlet port 12. In some embodiments, both first orifice and inlet port and circular. In some embodiment the first orifice nests inside the inlet port. In some embodiments the inlet port nests inside the first orifice. In some embodiments the piping between the inlet port and the first orifice are sealed to contain the resid process fluid piping. In some embodiments the first orifice is aligned so as to avoid closure no matter the orientation of the first plate 28.

In some embodiments the first plate 28 is floating between a rotor 60 and second plate 35. In some embodiments the first plate 28 is a rotary disc. In some embodiments the first plate 28 is ground and nitrided with a hardened face. In some embodiments the first plate 28 is configured to rotate or spin in a flat primary plane 20 coplanar the plane defined by the first plate 28. In some embodiments the first orifice 28 comprises a substantially planar annulus or ring defined by the first plate. The first plate 28 is configured to selectively revolve 360° clockwise or counterclockwise. In some embodiments the first plate 28 is configured to selectively revolve partially clockwise or counterclockwise. In some embodiments the rotation of the first plate 28 is limited.

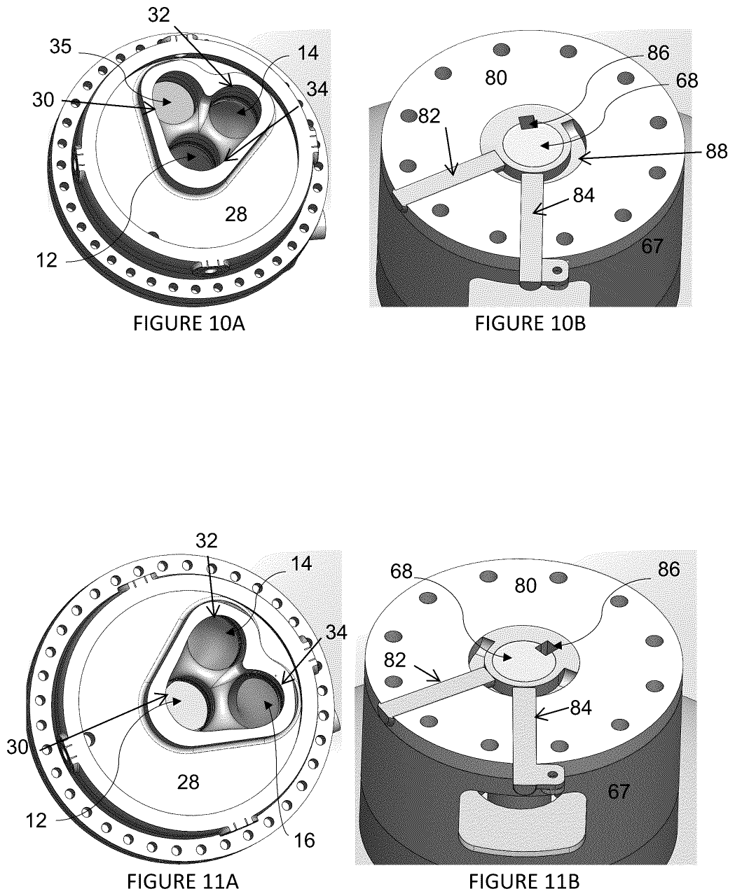

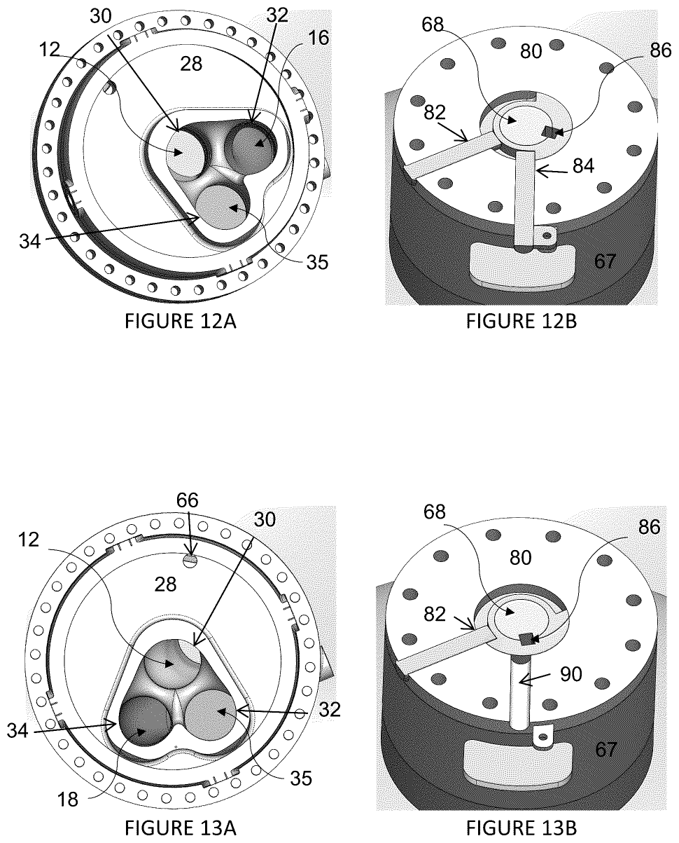

In some embodiments the valve 5 comprises a lockout collar 80. In some embodiments the lockout collar circumscribes the stem 68 and is housed in a stem shielding 67. In some embodiments the lockout collar further comprises one or more of the following: a stop pin 82, a lockout pin 84, a lockout pin channel 90, a key receiver 86 and a lockout channel 88. In some embodiments the stop pin 82 extends beyond the inner circumference of the lockout collar 80 into the lockout channel 88. FIGS. 10A-13B illustrate potential embodiments of the rotational range of a lockout channel 88 limited by the selective use of a lockout pin 84 and stop pin 82. In some embodiments the lockout channel 88 partially circumscribes the stem 68, thus when a key is placed in the key receiver 86, thus engaging the stem 69 to the collar 80, and the stop pin 82 is engaged with the channel 88, the stem can rotate back and forth the distance of the lockout collar 88. In some embodiments the lockout pin 84 can be selectively inserted to limit the rotational range of the lockout collar 80 to selectively closing the valve, opening the communication port to drum A 14 (see FIG. 10A), opening the communication port to both drum A 14 and drum B 16 (see FIG. 11A), opening the communication port to drum B 16 (see FIG. 12A). In some embodiments the lockout pin 84 is removed and the collar can rotate to align the second orifice 34 with the bypass communication port 46 (FIG. 13A-13B). In some embodiments the lockout channel 88 limits the degrees to which the rotor 60 and first plate 28 can rotate.

In some embodiments the valve 5 oscillates between opening drum A and closing drum B (FIG. 10A), opening both drum A and drum B (FIG. 13A), opening drum B while closing drum A (FIG. 12A). In some embodiments an intermediate position, shown in FIG. 11A, places the valve in communication with both drum A and drum B and allows the operator to reduce the flow of resid into the drum that is nearly filled, while warming up or heating the empty drum and to remove vapors and moisture from the empty drum.

In some embodiments the valve 5 may comprise a second plate 35. In some embodiments the second plate may include a plurality of communication ports 40, 42, 44, 46 matching with the plurality of housing ports 12, 14, 16, 18. In some embodiments the second plate may include a plurality of communication ports 40, 42, 44, 46 aligned with, or positioned so as to not obstruct passage of resid through the plurality of housing ports 12, 14, 16, 18. In some embodiments the communication ports further may include the inlet communication port 40, and the plurality of at least two outlet communication ports may include a drum A communication port 42, a drum B communication port 44. In some embodiments a bypass communication port 46 is provided. In some embodiments the inlet communication port 40 is aligned with the inlet port 12 and the first orifice, also called the inlet orifice 30. In some embodiments the drum A communication port 42 is aligned with the drum A port 14 and the second orifice 32. In some embodiments the drum B communication port 40 is aligned with the drum B port 16 and the third orifice 34.

In some embodiments the second plate 35 is adjacent the first plate 28 forming an interface 72 between the first plate 28 and the second plate 35. In some embodiments the interface comprises physical contact between the first plate 28 and the second plate 35. In some embodiments a force is exerted on a first side of the first plate 28 to increase the contact force at the interface 72. In some embodiments the force on the first side of the first plate 28 is activated by steam pressure formed in a gap 70 between the first plate 28 an the bottom of the rotor 60. In some embodiments as the first plate 28 rotates while in contact with the second plate 35, the first plate transits across the surface of the second plate. In some embodiments the first plate slides, scrapes or passes across the surface of the second plate 35, as illustrated in FIG. 9A-9C.

In some embodiments the first plate 28 further may include a valve seat 50. In some embodiments the valve seat may comprise a steam activated bellows whereby, upon activation, the force of the seat against the interface 72 is increased. In some embodiments the valve seat 50 isolates the process fluid, such as resid, from entering the interface or fouling the valve. In some embodiments the valve seat 50 is disposed in a pocket 52 formed around an orifice, such as the second orifice 30 or the third orifice 32. In some embodiments the interface between the orifice is improved by a ring that is manufactured and finished to minimize thermal expansion.

In some embodiments, both the second orifice 30 and the third orifice 32 have a valve seat. In some embodiments each valve seat 50 seats on the second plate in each of the positions shown in FIGS. 10A-13B. In the intermediate position, when both drum A and drum B are open the valve seats seat on both ports. Traditional switch valves do not seat on either seat when in the intermediate position, allowing resid to enter the body and foul the valve. In some embodiments another port in an additional position is provided so that all of the communication ports are sealed to prevent resid from entering the valve body and to isolate steam from entering the process.

In some embodiments the four-way switch valve may include a rotor 60 configured to selectively rotate the first plate 28 in the primary plane or rotation. In some embodiments a stem 68 mechanically connects the rotor 60 to the actuator 24. In some embodiments the rotor 60 is in mechanical communication with the first plate 28. In some embodiments the rotor 60 sits inside a cavity formed inside the housing 10. In some embodiments the cavity formed between the rotor 60 and the housing 10 is configured to be filled with steam. In some embodiments the rotor 60 further comprises a diverter 62. In some embodiments rotor/diverter is a cast part. In some embodiments the diverter 62 comprises a U-shaped surface and places the first orifice 30 in communication with the second orifice 32 and the third orifice 34, such that resid come from the furnace through a pipe to inlet port 12, through the inlet communication port 40, through the first orifice 30 and then is diverted back toward the first plate 28 and second orifice 32 and third orifice 34. In some embodiments the path into the diverter is opened irrespective of the orientation of the first plate 28. In some embodiments the first plate orientations illustrated in FIGS. 10A, 11A, 12A and 13A show the valve in various states of open and closed as discussed above.

In some embodiments the first plate 28 is a gate comprising valve seats, and the second plate 35 is a containment plate. In some embodiments the first plate is a containment plate and the second plate is a gate comprising valve seats.

In some embodiments a steam access plane 70, also called a gap, is formed between the bottom of the rotor 60 and the first plate 28. In some embodiments steam enters the housing 10 through steam ports 76 to fill the cavity. In some embodiments the internal steam chase 64 allows steam from cavity to enter the gap 70 and energize the first plate 28 with steam. In some embodiments a gap may be formed against the second plate 35 and the second plate 25 may be energized by the steam. In some embodiments the gap 70 is in fluid communication with the valve seat bellows 54 so that the bellows, and the valve seat is energized by steam pressure, thus increasing the force of the seat against the opposite plate to isolate the interior of the orifice from the valve body, or the resid from the valve body and the steam from the resid. In some embodiments the steam activates the gap 70 and increases the distance between the rotor 60 and the first plate 28. In some embodiments the steam activates the second plate and increases the distance between the second plate 35 and the housing 10. In some embodiments a force balancer, such as a bellville washer, is placed between the housing 10 and the rotor 60 to balance the force created by the valve seats 50. In some embodiments the steam pressure in the gap is greater than the pressure of the process inside the valve seat, thus if a potential leak formed were present the amount of resid able to enter the gap and valve body would be limited due to the lack steam entering through the space.

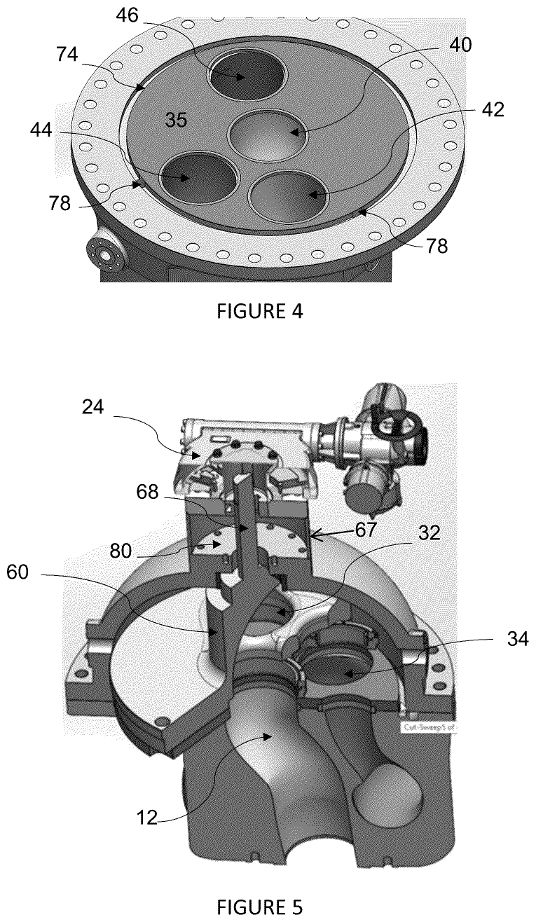

In some embodiments a discharge channel 74 is formed in the housing 10 and below the second plate 35. In some embodiments the discharge channel is isolated from the cavity formed above the rotor 60. In some embodiments the discharge channel circumscribes the inner wall of the housing. In some embodiments the discharge channel 74 is configured to receive any resid that is released from inside the valve seats 50. In some embodiments the discharge channel 74 is in fluid communication with discharge ports 78. As illustrated in FIG. 4, in some embodiments two discharge ports 78 are spaced equidistant the communication drum A port 42 and communication drum B port. In some embodiments discharge ports 78 remain closed during operation and are only opened to inspect the valve body for resid.

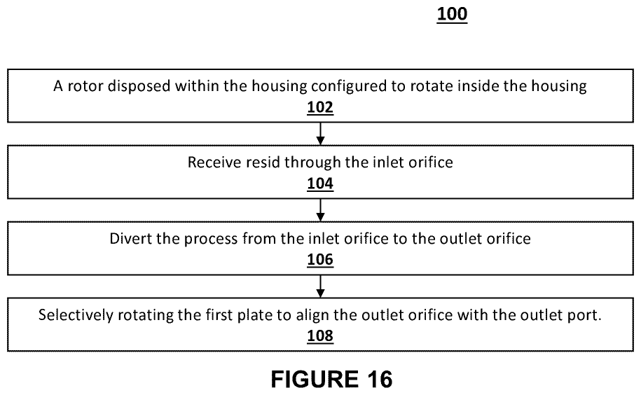

Referring now to FIG. 16, in some embodiments a method for selectively diverting resid through a valve includes providing a four-way switch vale that may include: a housing with a plurality of outlet ports including an inlet port and at least one outlet port; a rotor disposed within the housing configured to rotate within the housing; a substantially flat first plate coupled to the rotor the first plate may include a plurality of orifices including an inlet orifice coaxially aligned with the inlet port and the first plate may include at least one outlet orifice where the rotor places the plurality of orifices in fluid communication; and a second substantially flat plate adjacent the first plate and coupled to the housing, the second plate may include a plurality of second plate ports aligned with the plurality of outlet ports. The method also includes receiving process through the inlet port and the inlet orifice. The method also includes diverting the process from the inlet orifice to the at least one outlet orifice; and selectively rotating the first plate to align the at least one outlet orifice with the second plate.

The method may include rotating the rotor to selectively align the at least one outlet orifice with second plate port to open the valve, or selectively aligning the at least one outlet orifice with the second port to partially open the valve, or selectively aligning the outlet with the second plate to close the valve.

Structure for certain embodiments of the invention is assigned the following reference numbers:

| Ref No. | Structure |
|---|---|
| 5 | Valve |
| 10 | housing |
| 12 | Inlet port |
| 14 | Drum A port |
| 16 | Drum B port |
| 18 | Bypass port |
| 20 | Primary rotational plane |
| 22 | Primary axis (stem) |
| 24 | Actuator |
| 28 | First plate |
| 30 | First orifice |
| 32 | Second orifice |
| 34 | Third orifice |
| 35 | Second plate |
| 40 | Inlet communication port |
| 42 | Communication Drum A port |
| 44 | Communication Drum B port |
| 46 | Communication Bypass port |
| 50 | Valve seat |
| 52 | Pocket |
| 52 | Pocket |
| 54 | Bellows |
| 56 | Ring |
| 60 | Rotor |
| 62 | Diverter |
| 64 | Internal steam chase |
| 66 | steam access |
| 67 | Stem shielding |
| 68 | Actuator Stem |
| 70 | Gap |
| 72 | Interface |
| 74 | Discharge channel |
| 76 | Steam port |
| 78 | Discharge port |
| 80 | Lockout collar |
| 82 | Stop pin |
| 84 | Lockout pin |
| 86 | Key |
| 88 | Lockout channel |
| 90 | Lockout pin channel |

In closing, it is to be understood that the embodiments of the disclosure disclosed herein are illustrative of the principles of the present disclosure. Other modifications that may be employed are within the scope of the disclosure. Thus, by way of example, but not of limitation, alternative configurations of the present disclosure may be utilized in accordance with the teachings herein. Accordingly, the present disclosure is not limited to that precisely as shown and described.

1. A four-way switch valve comprising:
a housing comprising a plurality of communication ports further comprising an inlet port and at least two outlet ports; and
a substantially planar first plate disposed within the housing wherein the first plate further comprises a plurality of orifices wherein the first plate is configured to selectively rotate to selectively and at least partially open or close communication between at least two of the plurality of communication ports.

2. The four-way switch valve of claim 1 wherein the first plate comprises a first orifice, wherein the first orifice and the inlet port are coaxially aligned.

3. The four-way switch valve of claim 1, wherein the first plate is configured to rotate in a primary plane formed by the first plate.

4. The four-way switch valve of claim 1, wherein the first plate is configured to selectively revolve clockwise or counterclockwise.

5. The four-way switch valve of claim 1, further comprising a second plate disposed within the housing and adjacent the first plate to form an interface between the first plate and the second plate wherein the second plate comprises a plurality of communication ports matching with the plurality of housing communication ports, wherein the communication ports further comprise the inlet port, and the plurality of at least two outlet ports comprise a drum A communication port, a drum B communication port and a bypass communication port.

6. The four-way switch valve of claim 5, wherein the first plate further comprises at least one valve seat disposed in the at least one of the plurality of orifices and configured to isolate the at least one of the plurality of orifices from the interface.

7. The four-way switch valve of claim 5, wherein the first plate further comprises a pocket formed in the distal edge of the at least one first plate orifice wherein the pocket is configured to receive a valve seat configured to substantially seal against the second plate.

8. The four-way switch valve of claim 5, further comprising a rotor configured to selectively rotate the first plate.

9. The four-way switch valve of claim 8, wherein the rotor further comprises a diverter configured to place the first orifice in fluid communication with the second orifice and the third orifice.

10. The four-way switch valve of claim 8, further comprising a steam access plane adjacent the rotor wherein the steam access plane is configured to allow steam to energize the first plate and expand the distance between the rotor and the first plate and increase the force the first plate exerts against the second plate.

11. The four-way switch valve of claim 10 further comprising a valve seat wherein the valve seat further comprises a selectively extendable bellows in fluid communication with the steam access plane and wherein the bellows is configured to energize with steam pressure and increase a force between the valve seat and the second plate.

12. A four-way switch valve comprising:
a housing comprising plurality of housing ports;
a first plate disposed within the housing, the first plate comprising a plurality of orifices wherein the first plate is configured to rotated in a primary plane, a second plate disposed within the housing adjacent the first plate and fixed to the housing, the second plate comprising a plurality of communication ports aligned with the housing ports; and
a rotor disposed within the housing and configured to place in fluid communication the plurality of orifices and wherein the rotor is in mechanical communication with the first plate and configured to selectively rotate the first plate around a primary axis to selectively orient the plurality of orifices in the first plate in relation to the plurality of communication ports in the second plate.

13. The four-way switch valve of claim 12, wherein the rotor is configured to rotate clockwise or counterclockwise.

14. The four-way switch valve of claim 12, further wherein the plurality of orifices in the first plate comprise an inlet orifice, a first orifice and a second orifice, and the second plate comprises an input communication port aligned with the inlet orifice, a drum A communication port aligned with a drum A housing port, a drum B communication port aligned with a drum B housing port, and a bypass communication port aligned with a bypass housing port, and wherein the rotor is configured to selectively rotate the first plate to selectively orient the plurality of orifices in relation to the plurality of communication ports.

15. The four-way switch valve of claim 12, further comprising a valve seat wherein at least one of the plurality of orifices further comprises at least one valve seat circumscribing the at least one of the orifices.

16. The four-way switch valve of claim 12, further comprising a valve seat wherein at least one of the plurality of communication ports further comprises at least one valve seat circumscribing the at least one of the communication ports.

17. The four-way switch valve of claim 12, further comprising a gap between the first plate and the rotor and the first plate wherein the gap is configured to be energized by steam to increase the distance of the gap.

18. The four-way switch valve of claim 12, wherein the rotor further comprises a diverter configured to place in communication the inlet orifice with the second and third orifices.

19. A method for selectively diverting resid through a four-way valve, the method comprising:
providing a four-way switch vale comprising:
a housing comprising an inlet port an outlet port;
a rotor disposed within the housing configured to rotate inside the housing;
a first plate coupled to the rotor the first plate further comprising an inlet orifice and an outlet orifice wherein the rotor is configured to selectively orient the outlet orifice in relation to the outlet port; and
a second plate adjacent the first plate, the second plate comprising an inlet communication port and an outlet communication port;
receiving process through the inlet orifice;
diverting the process from the inlet orifice to the outlet orifice; and
selectively rotating the first plate to align the outlet orifice with the outlet port.

20. The method of claim 19 further comprising rotating the rotor to selectively orienting the outlet orifice to not align with the outlet port to close the valve.
